(19) United States
(12) Patent Application Publication
(10) Pub. No.: US 2024/0337722 A1
(43) Pub. Date: Oct. 10, 2024

(54) SYSTEM AND METHOD FOR SUPPORTING RIS BEAMFORMING IN WIRELESS NETWORKS

(71) Applicant: JIO PLATFORMS LIMITED, Ahmedabad (IN)

(72) Inventors: Vinay SHRIVASTAVA, Bangalore (IN); Satish Nanjunda Swamy JAMADAGNI, Bangalore (IN); Mathew OOMMEN, Mumbai (IN); Surabhi KARANDIKAR, Nagpur (IN)

(73) Assignee: JIO PLATFORMS LIMITED, Ahmedabad (IN)

(21) Appl. No.: 18/579,271

(22) PCT Filed: May 27, 2023
(86) PCT No.: PCT/IB2023/055454

§ 371 Date: Jan. 12, 2024

(30) Foreign Application Priority Data
May 27, 2022 (IN) 202221030597

(51) Int. Cl. G01S 5/02; H04B 7/04

(52) U.S. Cl. CPC G01S 5/0273; G01S 5/0289; H04B 7/04013

(57) ABSTRACT

The present disclosure provides a system and method for supporting beam forming in wireless networks with zero signaling overhead in operation. The system includes a reconfigurable intelligent surface (RIS) controller associated with a RIS panel enabling a communication between an access point and one or more user equipment's (UEs) autonomously in the wireless network. The RIS controller is configured to detect a target UE present in the vicinity of the RIS panel based on one or more signals received from the target UE, localize the target UE to identify a relative position of the target UE with respect to the one or more UEs, and select an optimum reflection coefficient matrix (RCM) associated with the RIS panel to enable beam forming towards the target UE.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to beam forming in wireless communication networks. In particular, the present disclosure relates to autonomous beam forming and tracking by a reconfigurable intelligent surface (RIS) in a wireless communication network.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

The current fifth generation (5G) wireless communication technology being developed in the third-generation partnership project (3GPP) is meant to deliver higher multi-giga bits per second (Gbps) peak data speeds, ultra-low latency, improved reliability, massive network capacity, increased availability, and a more uniform user experience to more users. Higher performance and improved efficiency empower new user experiences and connect new industries. Some of the objectives have been met, but there are still quite a few issues that need to be resolved especially when it comes to accommodating industry verticals, architectures to support private networks, and support flexible network deployments, etc.

In view of the above, a sixth generation (6G) network architecture capable of addressing the issue of network flexibility was proposed. The proposed 6G network should be capable of implementing new emerging technologies such as artificial intelligence, terahertz communications, optical wireless technology, free space optic network, three-dimensional networking, quantum communications, unmanned aerial vehicle, cell-free communications, integration of wireless information and energy transfer, integration of sensing and communication, integration of access-backhaul networks, dynamic network slicing, holographic beamforming, and big data analytics.

One such emerging technology that is being proposed for use with 5G and beyond 5G networks is reconfigurable intelligent surfaces (RISs). RIS corresponds to smart reflecting surfaces comprising many small reconfigurable meta-material elements also called “unit cells,” which enable controlling the propagation environment through tune-able scatterings of electromagnetic waves. These intelligent surfaces have reflection, refraction, and absorption properties, which are reconfigurable and adaptable to the radio channel environment. RISs enable control of radio signals between a transmitter and a receiver in a dynamic and a goal-oriented way, thus, turning the wireless environment into service providing enhancements of various network Key Performance Indicators (KPIs) such as capacity, coverage, energy efficiency, positioning, and security.

The RIS can construct an intelligent and programmable radio environment in a controllable way and may perform passive reflection, passive absorption, passive scattering, and push the physical environment to change towards being intelligent and interactive. The RIS may change the electromagnetic characteristics of the elements and generate phase shift independently on incident signals without using any radio frequency (RF) signal processing. Also, RIS technology has many technical features beyond current mainstream technology. Compared with massive multi-input multi-output (MIMO) system, RIS-aided wireless network hugely improves system performance by smartly optimizing the signal propagation.

The currently available RIS system provides a passive reflecting surface which is dependent on an access point for reflective beam forming. This dependency creates latency during high traffic or when a large number of users need to be catered for.

There is, therefore, a need in the art to provide an RIS system that can overcome the shortcomings of the existing prior arts.

### OBJECTS OF THE PRESENT DISCLOSURE

Some of the objects of the present disclosure, which at least one embodiment herein satisfies are as listed herein below.

It is an object of the present disclosure to provide autonomous reflective beamforming in reconfigurable intelligent surfaces (RISs).

It is an object of the present disclosure to identify and continuously track the positions of one or more user equipment's (UEs) within a coverage area of the RIS autonomously.

It is another object of the present disclosure to localize the UEs and direct a beam from an access point towards the localized UE based on an optimal reflection coefficient matrix (RCM).

It is yet another object of the present disclosure to provide a communication technology agnostic autonomous beam forming at the RIS.

It is yet another object of the present disclosure to train a neural network to obtain an RCM codebook based on different UE locations.

It is yet another object of the present disclosure to use multiple variations of deep neural networks for triggering autonomous beamforming in the RIS.

It is yet another objective of the present disclosure to provide a joint sensing and communication system.

It is yet another objective of the present disclosure to provide a joint sensing and communication using IRS for autonomous beam management and tracking.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for enabling autonomous beam forming in a wireless network. The system includes a reconfigurable intelligent surface (RIS) controller associated with a RIS panel enabling a communication between an access point and one or more user equipment's (UEs) in the wireless network, wherein the RIS controller is configured to detect a target UE present in the vicinity of the RIS panel based on one or more signals received from the target UE, localize the target UE to identify a relative position of the target UE with respect to the one or more UEs, and select a first optimum reflection coefficient matrix (RCM) associated with the RIS panel to enable beam forming towards the target UE.

In some embodiments, the selected first optimum RCM may enable optimal reflection of a beam from the access point towards the target UE.

In some embodiments, the RIS panel may include one or more reflecting elements and one or more sensing elements.

In some embodiments, the one or more sensing elements may assist the RIS controller to detect the presence of the target UE, and detect a movement associated with the target UE.

In some embodiments, the RIS controller may be configured to receive, from the one or more sensing elements, one or more uplink (UL) transmissions associated with the target UE and estimate an angle of arrival (AoA) associated with the target UE based on the received one or more UL transmissions.

In some embodiments, the RIS controller may be configured to select a second optimum RCM based on the detected movement associated with the target UE.

In some embodiments, the RIS controller may be configured to select the first and the second optimum RCM from an RCM lookup table obtained based on training a neural network for different RCM associated with different UE locations.

In some embodiments, the RIS controller may be configured to form reflection beams based on at least one of the selected first and second optimum RCM to direct one or more signals from the access point towards the target UE.

In some embodiments, the RIS controller may be configured to group the one or more reflecting elements and the one or more sensing elements in an array to form a plurality of non-uniform sub-arrays and create an operating schedule for the plurality of non-uniform sub-arrays to serve the one or more UEs in the wireless network.

In another aspect, the present disclosure relates to a method for enabling autonomous beam forming in a wireless network comprising RIS controller associated with a RIS panel enabling communication between an access point and one or more user equipment's UEs. The method includes detecting, by the RIS controller, a target UE present in the vicinity of the RIS panel based on one or more signals received from the target UE, localizing, by the RIS controller, the target UE to identify a relative position of the target UE with respect to the one or more UEs, and selecting, by the RIS controller, a first optimum RCM associated with the RIS panel to enable beam forming towards the target UE.

In some embodiments, the method may include detecting, by the RIS controller via the one or more sensing elements, at least one of the presence of the target UE, and a movement associated with the target UE.

In some embodiments, the method may include receiving, by the RIS controller, one or more UL transmissions associated with the target UE from the one or more sensing elements, and estimating, by the RIS controller, an AoA associated with the target UE based on the received one or more UL transmissions.

In some embodiments, the method may include selecting, by the RIS controller, a second optimum RCM based on the detected movement associated with the target UE.

In some embodiments, the method may include grouping, by the RIS controller, the one or more reflecting elements and the one or more sensing elements in the array to form a plurality of non-uniform sub-arrays, and creating, by the RIS controller, an operating schedule for the plurality of non-uniform sub-arrays to serve the one or more UEs in the wireless network.

In some embodiments, the method may include selecting, by the RIS controller, the first and the second optimum RCM from a RCM lookup table obtained based on training a neural network for different RCM associated with different UE locations.

In some embodiment, the method may include forming, by the RIS controller, reflection beams based on at least one of the selected first and second optimum RCM to direct one or more signals from the access point towards the target UE.

In another aspect, the present disclosure relates to a UE including one or more processors, and a memory operatively coupled to the one or more processors, wherein the memory includes processor-executable instructions, which on execution, cause the one or more processors to transmit one or more UL signals to a RIS controller to provide a location of the UE, and receive signals from an access point through one or more reflection beams formed by the RIS controller based on a selected optimal RCM.

In another aspect, the present disclosure relates to a non-transitory computer readable medium including one or more instructions stored thereupon that when executed by a processor cause the processor to detect a target UE present in the vicinity of a RIS panel based on one or more signals received from the target UE, localize the target UE to identify a relative position of the target UE with respect to one or more UEs present in a wireless communication network, and select an optimum RCM associated with the RIS panel to enable beam forming towards the target UE.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIGS. 1A-1D illustrate exemplary use case scenarios (102, 104, 106, 108, respectively) for implementing a reconfigurable intelligent surface (RIS) in a wireless communication network, in accordance with some embodiments of the present disclosure.

FIG. 2 illustrates an exemplary channel impulse response (200) for a RIS-assisted wireless communication network, in accordance with some embodiments of the present disclosure.

FIG. 3 illustrates an exemplary system (300) for autonomous beam forming, in accordance with some embodiments of the present disclosure.

FIG. 4 illustrates beam forming (400) at the RIS, in accordance with some embodiments of the present disclosure.

FIG. 5A illustrates an exemplary RIS meta surface (500-A) comprising reflecting elements and sensing elements, in accordance with some embodiments of the present disclosure.

FIG. 5B illustrates an exemplary distribution (500-B) of the sensing elements on the RIS meta surface, in accordance with some embodiments of the present disclosure.

FIG. 6 illustrates an arrangement (600) of potential pilots in an uplink (UL) signal from a user equipment (UE), in accordance with some embodiments of the present disclosure.

FIG. 7 illustrates an exemplary real world set up (700) for training and deployment of the system for autonomous beam forming, in accordance with some embodiments of the present disclosure.

FIG. 8 illustrates an exemplary representation (800) of angle of arrival (AoA) associated with UE UL signals at the sensing elements on the RIS meta surface, in accordance with some embodiments of the present disclosure.

FIG. 9 illustrates an exemplary time division duplexing scheme (900) implementation between the UE and the RIS, in accordance with some embodiments of the present disclosure.

FIG. 10A illustrates an exemplary frequency division duplexing (FDD) scheme (1000-A) implementation between the UE and the RIS, in accordance with some embodiments of the present disclosure.

FIG. 10B illustrates an exemplary distribution (1000-B) of sensing elements on the RIS meta surface for use with the FDD scheme, in accordance with some embodiments of the present disclosure.

FIG. 11 illustrates an exemplary system setup (1100) for autonomous beam forming, in accordance with some embodiments of the present disclosure.

FIG. 12 illustrates a deep neural network (DNN) architecture (1200) implemented for training the RIS beamforming, in accordance with some embodiments of the present disclosure.

FIG. 13 illustrates an exemplary flow diagram (1300) associated with RIS training phase, in accordance with some embodiments of the present disclosure.

FIG. 14 illustrates an exemplary flow diagram (1400) associated with RIS training for autonomous beam forming in TDD systems, in accordance with some embodiments of the present disclosure.

FIG. 15 illustrates an exemplary flow diagram (1500) associated with RIS training for autonomous beam forming in FDD systems, in accordance with some embodiments of the present disclosure.

FIG. 16 illustrates an exemplary flow diagram (1600) associated with autonomous beam forming at the RIS in a practical implementation, in accordance with some embodiments of the present disclosure.

FIG. 17 illustrates an exemplary autonomous beaming forming system (1700) at the RIS for supporting multiple UEs, in accordance with some embodiments of the present disclosure.

FIG. 18 illustrates an exemplary flow chart for a method (1800) for enabling autonomous beamforming in a wireless network, in accordance with some embodiments of the present disclosure.

FIG. 19 illustrates an exemplary computer system (1900) in which or with which embodiments of the present disclosure may be implemented.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. Various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “RIS” may refer to a reconfigurable intelligent surface or intelligent reflective surface (IRS) or smart reflecting surfaces.

The term “autonomous” may refer to a stand-alone mode of working of the RIS.

The term “autonomous beam forming” may refer to beam forming at the RIS in the stand-alone mode with no assistance from an access point.

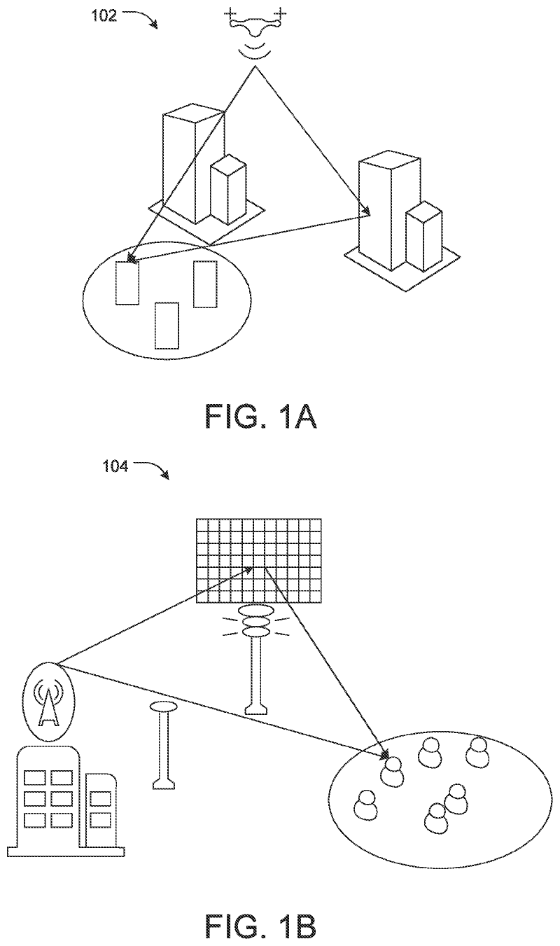

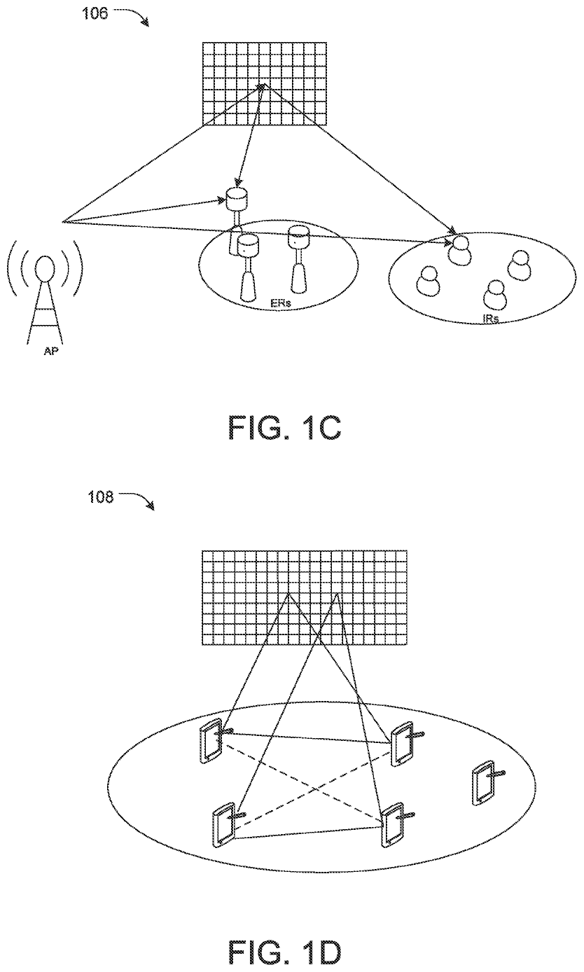

The various embodiments throughout the disclosure will be explained in more detail with reference to FIGS. 1-19.

FIG. 1A-1D illustrate various exemplary use case scenarios (102, 104, 106, 108, respectively) related to the implementation of a reconfigurable intelligent surface (RIS) in a wireless communication network, in accordance with some embodiments of the present disclosure.

RIS is implemented in various scenarios due to many advantages associated with it. One of the major advantages is that the RIS element is completely passive and therefore has low power consumption, making it environmentally friendly and sustainable green. Further, it does not include high cost components such as analog-to-digital converter/digital-to-analog converter (ADC/DAC) and power amplifier making large-area deployment feasible. In addition, electromagnetic waves may be reconstructed at any point on its continuous surface and thus forms any shape to adapt to different application scenarios and support higher spatial resolution.

Further, the RIS intelligently controls the propagation environment, improves transmission reliability, and achieves a higher spectrum efficiency. RIS may be applicable to the following typical scenarios: (i) overcome the Non-line-of-sight (NLOS) limitation and deal with the coverage hole problem in an environmentally friendly manner, (ii) serve cell edge users, relief multi-cell co-channel interference, expand coverage, and implement dynamic mobile user tracking, (iii) reduce electromagnetic pollution and solve the multi-path problem, (iv) positioning, perception, holographic communication, and virtual reality.

Based on the above advantages, the RIS may be deployed in one more scenarios as illustrated in FIGS. 1A-1D.

Referring to FIG. 1A, an example implementation scenario for the RIS includes a first scenario (102) depicting an RIS-assisted communication between one more UEs and an unmanned aerial vehicle (UAV). In FIG. 1A, the RIS is deployed on ground, for example, on the buildings for assisting communication between the UAV and the UE is shown. In some embodiments, the RIS may be attached to the UAV for leveraging smart passive reflection from the sky.

FIG. 1B illustrates a second scenario (104) depicting an RIS-assisted millimeter wave (mm wave) communication. In general, mm wave communication has a very short transmission range, and the use of RIS in such communication enhances the transmission range. In FIG. 1B, the RIS panels enhancing the communication between an access point and the user devices is shown.

FIG. 1C shows a third scenario (106) illustrating the use of RIS in simultaneous wireless information and power transfer (SWIPT) mode of operation. In FIG. 1C, far-field power transfer using RIS is shown. The RIS-assisted SWIPT system enables wireless transfer from an access point (AP) to multiple-antenna receivers, which include information receivers (IRs) and energy receivers (ERs).

FIG. 1D shows a fourth scenario (108) illustrating an RIS-assisted device-to-device (D2D) communication. In FIG. 1D, D2D communication using RIS is shown. RIS enhances received signal power at distant D2D users thereby enhancing the quality of service (QoS) in the D2D communication.

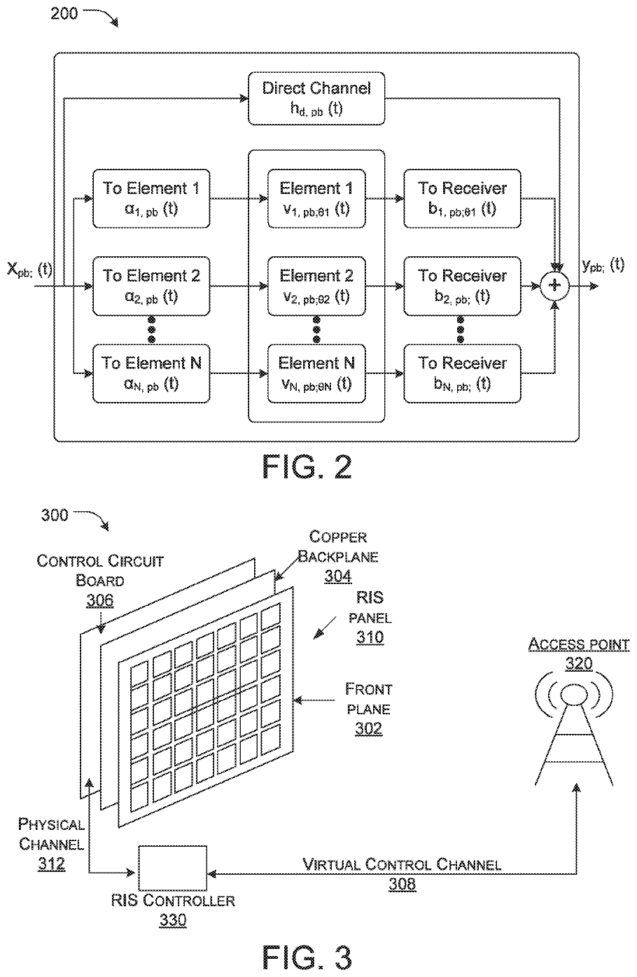

FIG. 2 illustrates an exemplary channel impulse response (200) for an RIS-assisted wireless communication network, in accordance with some embodiments of the present disclosure.

In FIG. 2, an end-to-end impulse response associated with an RIS system is shown. In general, for conventional channel models, the impulse response may be given in terms of a_{n,pb}(t), b_{n,pb}(t), and h_{n,pb}(t), whereas for channel model associated with RIS system includes RIS control variables θ₁, . . . , θ_{N} in v_{n,pb}(t), signifying the phase shift provided by the RIS.

FIG. 3 illustrates an exemplary system (300) for autonomous beam forming, in accordance with an embodiment of the present disclosure.

In FIG. 3, an RIS panel (310), an access point (320), and an RIS controller (330) are shown. The RIS panel (310) includes a front plane (302), a back plane (304), and a control circuit board (306) connected to the RIS controller (330) over a physical channel (312). Further, the RIS controller (330) is connected to the access point (320) over a virtual control channel (308). The access point (320) may include any node capable of providing communication services to a user equipment (UE) (not shown in FIG. 3), for example, without limitations, a wireless fidelity (Wi-Fi) access point, a base station, an evolved node B (eNode B), a fifth-generation node (gNodeB), etc. Further, the virtual control channel (308) between the RIS controller (330) and the access point (320) may include an over-the-air (OTA) channel such as, without limitations, an integrated access and backhaul (IAB) or a radio frequency (RF) channel.

In communication networks using RIS panels (310), the RIS panels (310) enable reflecting the uplink (UL) communication from the UE to the access point (320) and on the other end, reflecting the downlink (DL) communication from the access point (320) towards the UE. To enable signal reflection, a position associated with the RIS panel (310) may be controlled. For example, a virtual tilt associated with the RIS panel (310) is controlled to achieve maximum reflection of the signals. In the existing systems, the virtual tilt (angle of beam reflection) of the RIS panel (310) is controlled by the access point (320). There are two aspects to control the RIS panel tilt by the access point (320). In a first aspect, the access point (320) collects a set of signal interference plus noise ratio (SINR) profile via enhanced user measurement at the access point (320) and then generates a RF signature profile for a region in the vicinity of the RIS. In a second aspect, a scheduler in the access point (320) computes the virtual tilts (or associated beam reflection angles) necessary to achieve a SINR objective. Therefore, in the existing system, the RIS panel (310) may sense UL signals from the UE and send the same to the access point (320) such that the access point (320) computes the tilt control information for a given time period and convey that information to the RIS panel (310) through the virtual control channel (308). The tilt control information includes parameters associated with the RIS panel's reflection characteristics, for example, a reflection coefficient matrix (RCM). In existing system, the RCM is calculated by the access point (320) and the optimal RCM is sent to the RIS controller (330) for controlling the tilt of the RIS panel (310). In other words, the RIS panel (310) tilt is dependent on a decision from the access point (320).

In accordance with the present disclosure, an optimum RCM is calculated at the RIS controller (330) to enable autonomous beam forming at the RIS panel (310) in a stand-alone mode, i.e., without depending on the access point (320). Further, to calculate the optimum RCM, an exact position of the UE may be known so that the RIS controller (330) may provide optimum tilt of the RIS panel (310). In accordance with some embodiments, the RIS controller (330) may perform UE localization based RIS beam formation. By way of example, without limitations, in some embodiments, the RIS controller (330) may sense a relative position of an active UE under its coverage and select a first optimal beam RCM to maximize the received SINR (or an equivalent signal quality parameter) in UL and DL autonomously. In an embodiment, the relative position of the UE may be sensed, by the RIS controller (330), based on estimating an angle of arrival (AoA) of the UL signal from the UE at the RIS panel (310). In real time, the active UE may keep moving under the RIS coverage area leading to the change in AoA and requirement for change in the optimum RCM. In some embodiments, the RIS controller (330) may autonomously update the optimal beam RCM i.e., select a second optimal RCM based on detecting a movement associated with the active UE. In an embodiment, the RIS controller (330) includes an RCM codebook, wherein the RCM codebook includes the RCM at a particular UE location and is obtained by training a neural network at different locations of the UE. For example, the RIS controller (330) may select the first and second optimum RCM from the RCM codebook.

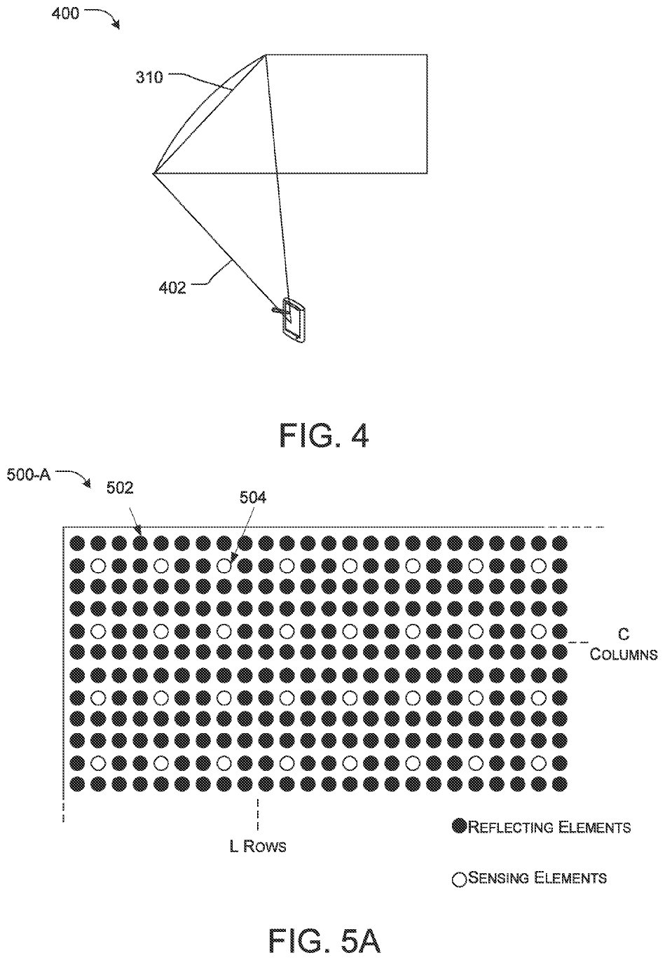

FIG. 4 illustrates beam forming (400) at the RIS, in accordance with some embodiments of the present disclosure.

In FIG. 4 a beam (402) formed at the RIS panel (310) is shown. Accordingly, the RIS system (300) may be configured to generate a reflective beam for directing the DL signal from the access point (320) towards the UE or the UL signal from the UE towards the access point (320).

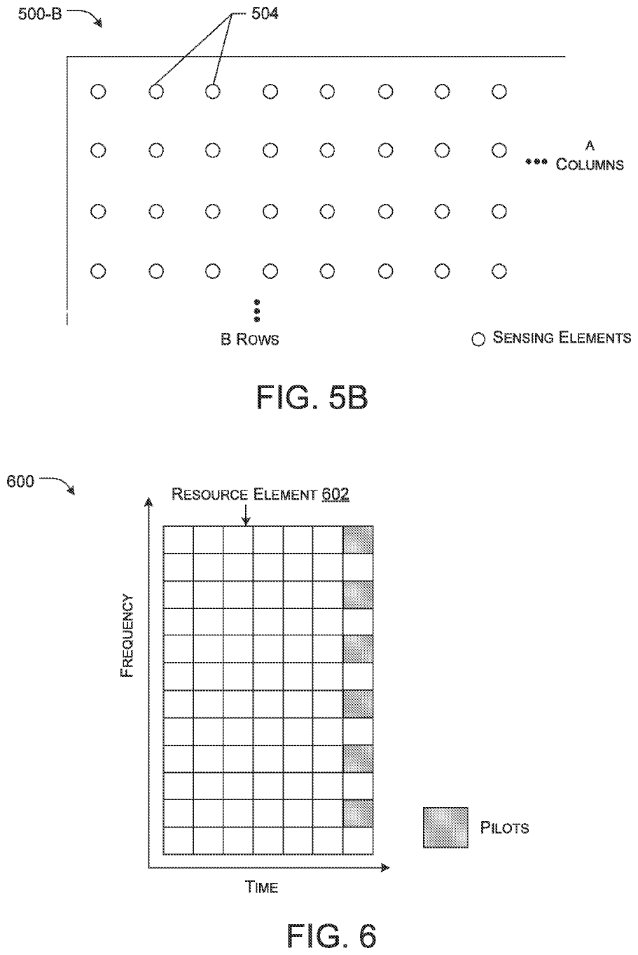

FIG. 5A illustrates an exemplary RIS meta surface (500-A) comprising reflection elements and sensing elements, in accordance with some embodiments of the present disclosure.

In FIG. 5A, the RIS meta surface (500-A) comprising reflecting elements (502) and sensing elements (504) arranged in L-rows and C-columns is shown. The sensing elements (504) may sense the presence of an active UE in the vicinity of the RIS panel (310). For example, the active UE may be present in a line of sight (LoS) of the RIS panel or in a distance at which the reflections from the RIS panel may be received without any loss. In some embodiments, the sensing elements (504) sense the signal from the active UE based on an AoA of UL pilot signals from the UE. The information from the sensing elements (504) may be used by the RIS controller (330) for determining the relative location of the UE, i.e., perform localization and thereby select an appropriate RCM for beam forming.

FIG. 5B illustrates an exemplary distribution (500-B) of the sensing elements on the RIS meta surface, in accordance with some embodiments of the present disclosure.

In FIG. 5B, a distribution of the sensing elements (504) on the RIS meta surface is shown. The sensing elements (504) are distributed as A-rows and B-columns. When combined, the activated sensing elements (504) may constitute an RF sensing sub-array as shown in FIG. 8. This active sub-array formation may provide the RIS controller (330) of FIG. 3 with a capability to estimate UL angle of arrival. In some embodiments, the sensor array may be either one dimensional (all sensors in a single line) and may measure an UL AoA along the horizontal axis. In some other embodiments, the sensor array may be two dimensional and may measure UL direction of arrival or AoA along both the horizontal and vertical axes.

In an embodiment, sensing of active UE in an RIS coverage area is achieved by employing cyclically shifted reference symbols or pilots in the UL. These pilots or reference symbols are used in the uplink to aid channel sounding by the access point (320) of FIG. 3. These pilot symbols may correspond to a family of pseudo normal sequences, with very good correlation properties, for example, without limitations, a zero-forcing (ZF) sequence, Gold sequence, etc. The RIS controller (330) of FIG. 3 may use a mechanism of correlating the shifted reference symbols or pilot symbols with a signal received from the active UE in the RIS coverage region.

FIG. 6 illustrates an arrangement (600) of potential pilots in an UL signal from a user equipment, in accordance with some embodiments of the present disclosure.

In FIG. 6, an exemplary arrangement (600) of UL pilot elements or resources elements (602) is shown. By way of example, without limitations, the arrangement (600) may include sounding reference signal (SRS) elements over a given 5G new radio (NR) system resource block (RB). In some embodiments, if a UE transmits a pilot denoted as s(t)∈C, assumed to have unit-magnitude elements ‘m’ to obtain a constant power level, the received reference signal for element ‘m’ may be given as follows:

$${y}_{m} ( t ) = {\sum }_{l = 1}^{L} {h}_{l , m} ( t ) + {n}_{m} ( t ) = {\sum }_{l = 1}^{L} {h}_{l}^{CH} {e}^{j ( m - 1 ) φ l} s ( t - {τ}_{l} ) + {n}_{m} ( t ) ,$$

where s(t−τₗ) is the delayed version of s(t) by the delay of τₗ. Further, nₘ(t) is the additive white gaussian noise (AWGN) noise at the receiver.

In some embodiments, the UE transmits a resource unit s(t), where the exact structure of the resource unit is known at the RIS controller (330). Since the cross-correlation between different cyclically shifted sequences from same root sequence is zero, the RIS controller (330) may estimate the channel h(t) by correlating y(t) with s(t).

$${h}^{\hat{}} \_m ( t ) = 〈 y\_m ( t ) , s ( t ) 〉$$

In some embodiments, for sensing the presence of an active UE, only a subset (even a single element) of the RIS sensing elements (504) of FIG. 5B needs to be activated. This makes the proposed mechanism very efficient.

In some embodiments, the RIS controller (330) of FIG. 3 may sense an active UE in its coverage area without a knowledge of the exact cyclic shift applied to the pilot sequence used by the active UE. This may be achieved by correlating a concatenated pilot reference signal with a received signal in a running window fashion. In such a case, the RIS controller (330) of FIG. 3 may traverse through all the possible shifts of the pilot sequence and compare it with a threshold. If the correlation of the concatenated pilot sequence is above a threshold T at an index iₜₕ, the RIS controller (330) may declare that the active UE is under the RIS coverage region.

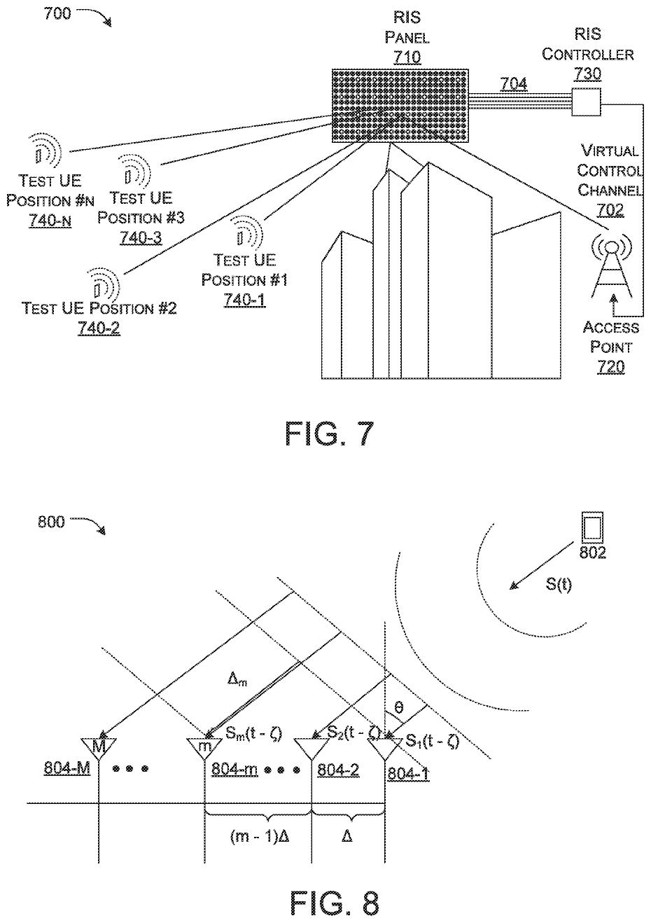

FIG. 7 illustrates an exemplary real world set up (700) for training and deployment of the system for autonomous beam forming, in accordance with some embodiments of the present disclosure.

In FIG. 7, a training set up (700) comprising a RIS panel (710), an access point (720), a RIS controller (730), and one or more test UEs (740-1, 740-2, 740-3 . . . 740-n) is shown. Further, the RIS panel (710) is connected to the RIS controller (730) by means of a physical channel (704). The access point (720) is connected to the RIS controller (730) by means of a virtual control channel (702). In some embodiments, the training set up (700) enables training a neural network associated with the RIS controller (730) to record a set of RCM associated with different UE locations to form RCM codebook. The training includes three phases. The first phase involves detecting the presence of an active UE in the RIS coverage area based on one or more pilot sequences received from the active UE, the second phase involves localizing the detected UE based on estimating an angle of arrival of the UL transmission from the active UE, and the third phase includes selecting an appropriate RCM from the codebook for reflective beam forming by the RIS.

In accordance with some embodiments, to train the neural network, the test UE (740) is placed at different positions (740-1 . . . 740-n) in the vicinity of the RIS coverage area and signals from the test UE (740) at each position is sent to the access point (720) to determine the RCM. The various RCM obtained is stored in the RCM codebook and may be used by the RIS controller (730) during the beam forming operation.

In an example embodiment, for training the neural network, the SRS of the 5G NR system is considered, wherein the length of the SRS sequence depends on a number of time-frequency physical resource blocks (PRBs) used in the transmission. A PRB is the smallest unit of resource block that can be allocated to the UE. In each PRB, there are six SRS resource elements (RE). The RE corresponds to one time-frequency instant. Hence, the received signal contains REs of each used PRB. The number of PRBs depends on the test UE (740) configurations. Further, a cyclic shift associated with the SRS may be varied from 1 to 8 to generate up to 8 different SRSs which are orthogonal to each other. The access point (720) may configure SRS for up to 8 UEs in the same sub-frame and frequency resources. However, to use different cyclic shifts, the cyclic shift multiplexed signals need to have same bandwidth to maintain orthogonally. It has to be understood that a number of SRS transmitted, and the cyclic prefix assigned to UEs can vary and also steps applied for all possible combinations of cyclic shift numbers used in the wireless technology may vary.

In an embodiment, a localization setup and mechanism for UL direction of arrival detection is illustrated with reference to FIG. 8.

FIG. 8 illustrates an exemplary representation (800) of AoA associated with UE UL signals at the sensing elements on the RIS meta surface, in accordance with some embodiments of the present disclosure.

The localization mechanism helps to identify the relative position of a sensed active UE (802). The peaks in the observed channel estimations may be extracted and organized in an A x B (=M) elements sensing matrix and the angle of arrival of a signal from a UE (802) to the RIS may be used for localization. For localization, all of the RIS sensing elements (804-1-804-M) may be activated and the array may be rotated in one direction at one time to measure the output power level. The rotation is done by weighing each array response and then combining them linearly. Output for one sample is formed by—

y(t)=w^{H}Ĥ,

where w is a weight vector.

The weight vector w is equal to the scanning vector a(θ_{B}), where the presumed angle θ_{B} is scanned over the angular region. This steering vector of sensing array elements is defined as follows for scanning angle θ_{B}:

A=[a(θ₁) a(θ₂) . . . a(B_{M})]

is the steering matrix

$$a ( {θ}_{B} ) = {[ \begin{matrix}1 & {e}^{j μ} & … & {e}^{j ( M - 1 ) μ}\end{matrix} ]}^{T} ,$$

$$where$$

$$μ = - k Δ sin {B}_{}$$

$$H = [ \begin{matrix}{h}_{1}^{CH} {a}_{1} ( {θ}_{1} ) & {h}_{2}^{CH} {a}_{1} ( {θ}_{2} ) & … & {h}_{L}^{CH} {a}_{1} ( {θ}_{L} ) \\ {h}_{1}^{CH} {a}_{2} ( {θ}_{1} ) & {h}_{2}^{CH} {a}_{2} ( {θ}_{2} ) & … & {h}_{L}^{CH} {a}_{2} ( {θ}_{L} ) \\ ⋮ & ⋮ & ⋱ & ⋮ \\ {h}_{1}^{CH} {a}_{M} ( {θ}_{1} ) & {h}_{2}^{CH} {a}_{M} ( {θ}_{2} ) & … & {h}_{L}^{CH} {a}_{M} ( {θ}_{L} ) ,\end{matrix} ] + {n}^{′}$$

The RIS receiver may have a set of scanning vectors in form of a matrix A corresponding to the possible range of UL signal arrival angles θ₁ to θₚ.

For each presumed angle, the output power is measured using—

$$P ( w ) = \frac{1}{K} {\sum }_{k = 1}^{N} {\vert y ( {t}_{k} ) \vert}^{2}$$

When the presumed angle θ_{B} is the same as the real angle of the signal, P(w) will have a peak in the spectrum.

For practical computations, the weight vector is normalized as:

$${W}^{↼} = \frac{a ( θ )}{\sqrt{{a}^{H} ( θ ) a ( θ )}}$$

$${P ( θ )}^{↼} = \frac{{a}^{H} ( θ ) \hat{R} a ( θ )}{{a}^{H} ( θ ) a ( θ )}$$

Upon detecting and localizing the UE in the RIS coverage area, the beam training stage occurs. RIS beam training is a stage where the UE location is known but the RIS has to decide which of the beam forming matrix or code book or RCM to use so that the beam from the access point is appropriately reflected towards the located UE.

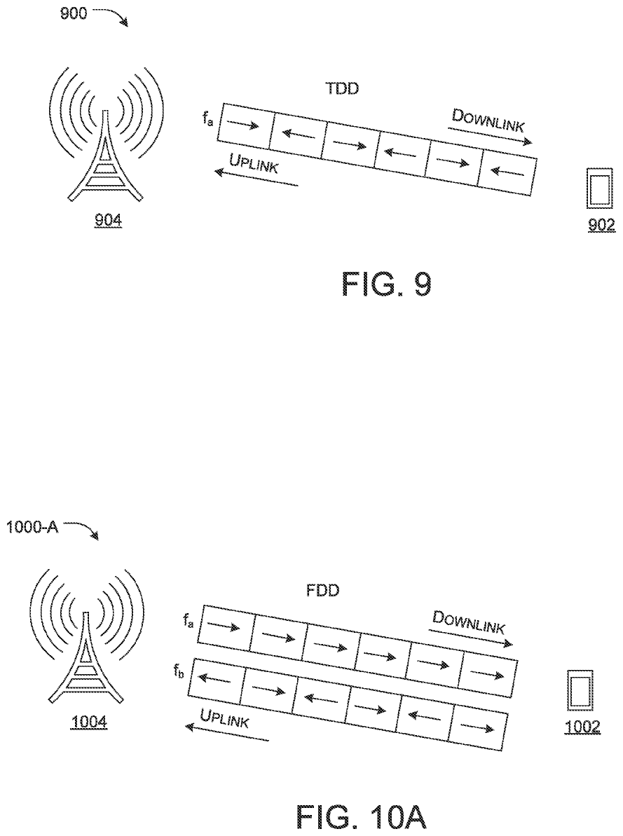

FIG. 9 illustrates an exemplary time division duplexing (TDD) scheme (900) implementation between the UE and the RIS, in accordance with some embodiments of the present disclosure. In FIG. 9, a TDD communication between an access point (904) and a UE (902) is shown. In general, TDD communication uses different time slots for uplink and downlink transmission. The TDD duplex scheme brings several advantages and flexibilities important to communication systems. One advantage is the channel reciprocity. Channel reciprocity means that the channel properties are the same for uplink and downlink.

Therefore, by estimating the channel in the uplink direction, downlink direction is also estimated assuming that the channel does not change in the estimation interval. As a result, the reciprocity leads to better transmit parameter optimization for resource allocation.

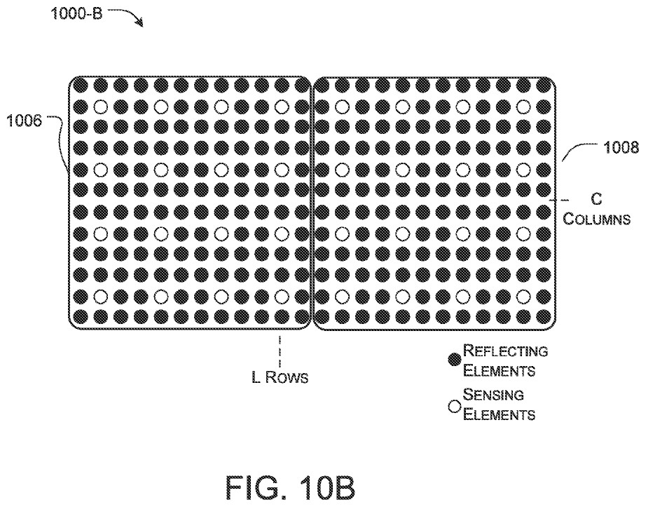

FIG. 10A illustrates an exemplary frequency division duplexing (FDD) scheme (1000-A) implementation between the UE and an access point, in accordance with some embodiments of the present disclosure.

In FIG. 10A, a FDD communication between the UE (1002) and the access point (1004) is shown. The FDD multiplexing operates UL and DL in separate frequency spectrum, hence, the channel reciprocity (as applicable for TDD UL-DL) is no longer valid. Hence, different reflection coefficient matrices are required for reflecting UL and DL links of same UE. In accordance with some embodiments, for enabling RCM allocation in FDD communication, the given RIS meta surface is virtually divided into two sections as explained below with reference to FIG. 10B.

FIG. 10B illustrates an exemplary distribution (1000-B) of sensing elements on the RIS meta surface for use with the FDD scheme, in accordance with some embodiments of the present disclosure.

In FIG. 10B, a virtually divided RIS meta surface comprising a first portion (1006) containing N/2 sensor elements and a second portion (1008) containing N/2 sensor elements is shown. FDD uses different frequencies for UL and DL, therefore the two different virtual regions or portions (1006, 1008) shall cater for FDD. In an example embodiment, the first portion (1006) containing N/2 elements may be used for UL communication from the UE (1002) to the access point (1004) and the second portion (1008) containing N/2 elements may be used for DL communication from the access point (1004) to the UE (1002).

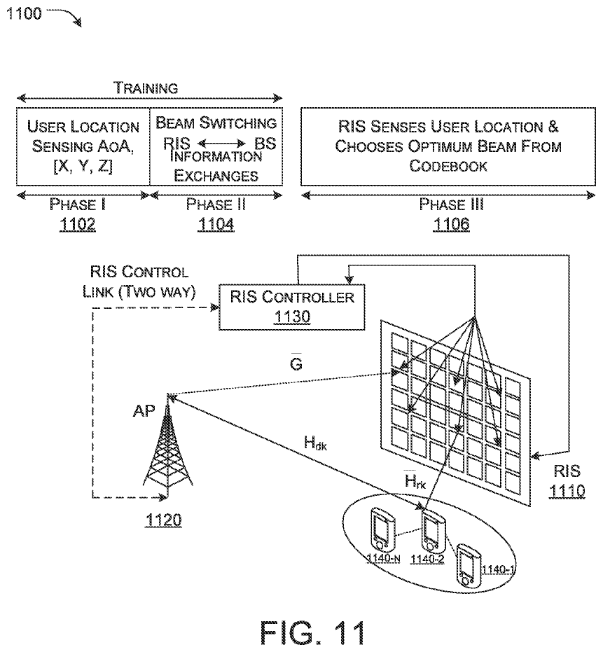

FIG. 11 illustrates an exemplary system setup (1100) for autonomous beam forming, in accordance with some embodiments of the present disclosure.

In FIG. 11, two major phases, i.e., the training phase and the RCM selection phase associated with autonomous beam forming at the RIS controller (1130) is shown. The training phase includes a first phase, phase 1 (1102) for UE location sensing and a second phase, phase 2 (1104) for beam switching with interactions between RIS controller (1130) and the access point (1120). Upon training the neural network associated with the RIS controller (1130), a RCM codebook is generated to enable autonomous beam forming at the RIS panel (1110). The selection phase (1106) selects RCM from the RCM codebook during practical implementation.

Referring to FIG. 11, the phase 1 (1102) forms a part of initial RIS deployment time training. The training phase may include the following steps:
1. The test UE (1140) sends constant pilot signals in the uplink for a training duration.
2. The RIS controller (1130) senses the user location in terms of the Angle of arrival A(Ø1) of the signal (not user coordinates [X, Y]) relative to the RIS and stores it locally.
3. The RIS controller (1130) then initiates a test code word selection for a sequence of beam reflection coefficients in the UL.
4. For each iteration of UL beam code word selection, the RIS controller (1130) seeks the respective test UE (1140) SINR observed at the access point (1120).
5. At the end of traversing through the possible code word in the RIS code book, the RIS controller (1130) marks the UE location against the beam codeword corresponding to the highest UL SINR observed at the access point (1120), creating one entry in the codebook lookup table. The training process is repeated by placing the test UE at various locations in given RIS coverage region.
   The second phase (1104) corresponds to the live network where the RIS controller (1130) aids the UE (1140) for communication with the access point (1120). The reflection coefficients chosen by RIS controller (1130) are directly mapped to the relative UE location, wherein the UE location is obtained based on a direction of arrival of the UL signal from the UE sensed by the sensing elements at the RIS panel (1110).

Any change in the UE location may be detected by the sensing elements in the RIS panel (1110) as a change in direction of arrival (DoA) from the UE (1140).

In some embodiments, if the UE (1140) and the access point (1120) use a TDD communication: the RIS controller (1130) may estimate the precise UE location (AoA) with the aid of the UL transmission sensing mechanism (sensing elements in the RIS panel (1110)). The RIS controller (1130) may then use this UE localization information to make optimum look up of beamforming codeword from the training codebook table, i.e., the RCM codebook obtained from phase 1 (1102). The RIS controller (1130) may perform a beamforming reflection of the access point (1120) signal to the target UE (1140) using the above selected beamforming codeword. In case the UE (1140) moves, the RIS sensing elements update the UE location to the RIS controller (1130). The RIS controller (1130) switches the beamforming codeword based upon updated UE location lookup from the training codebook table.

In some embodiments, the beamforming at the RIS panel (1110) is based on the angle of arrival of the UEs, wherein the angle of arrival keeps changing as the UEs move, making the beamforming process dynamic. In other words, the term “dynamic beamforming” may refer to the beamforming at the RIS controller (1130) based on the number of subpanels in an RIS panel (1110) and the location of the UEs.

In some embodiments, the RIS controller (1130) may perform RIS finger printing, sensing, and tracking of the UEs in the RIS coverage region where the RIS may use the disclosed mechanism of arriving at the precise UE position and help the access point (1120) with that information.

In some other embodiments, if the UE (1140) and the access point (1120) communicate using a FDD system: the RIS controller (1130) may include an additional training phase with the access point (1120) transmitting in the DL and the test UE (1140) performing channel estimation for various DL reflection codewords at a given UE location. Since there is no direct interface between the test UE (1140) and the RIS controller (1130), the reporting of SINR for each UL beamforming codeword happens via UE-access point feedback and then access point (1120) to RIS controller (1130).

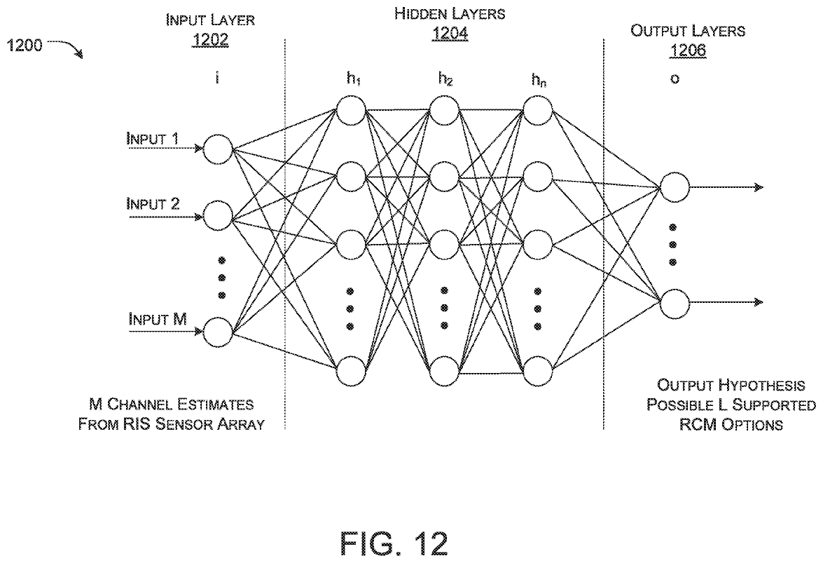

In some embodiments, a deep neural network may be used to select the optimum RCM at the RIS controller (1130). The proposed deep neural network (DNN) for selection of correct RCM is a multilayer perceptron (MLP) network, as discussed below with reference to FIG. 12. The DNN functionality may either be part of the RIS controller (1130) or may be on a cloud which is readily accessible to the RIS controller (1130) using a backhaul mechanism.

It may be noted that the MLP is suitable for classification problems where the output of the network is discrete or categorical and the input data is labelled. The design of the DNN depends on the corresponding problem, which is desired to be solved. The first step is to choose the correct network type, number of hidden layers, and number of nodes in each layer. Further, the activation functions and connections between nodes may be defined. These variables are called hyper-parameters, which determine the structure of a network. Once the hyper-parameters are determined, the network model needs to be trained and tested. Training means that the weights and biases of activation functions are adjusted to receive accurate estimations. Before the network can be trained, the weights and biases are initialized. This is required for the first iteration of the train. The training data contains the correct targets, i.e., the desired values for the responses associated with the inputs. These targets may be then compared against estimates of the outputs given by the network using a certain metric. One popular metric is the loss function (also called cost function). The loss function indicates how good the estimates are compared to the targets. Thus, the smaller the output of the loss function, the better the model is for the problem in question. The training may help to minimize the value of the loss function through multiple iterations. In each iteration, an example from the training data is fed to the input layer of the network. After this, the weights and biases are adjusted so that the value of the loss function decreases. There are multiple different methods to find the optimal weights and biases which minimize the loss function.

FIG. 12 illustrates a DNN architecture (1200) implemented for training the RIS beamforming, in accordance with some embodiments of the present disclosure.

In FIG. 12, the DNN containing an input layer (1202), an output layer (1206), and at least two hidden layers (1204), are shown. In general, the number of hidden layers (1204) is chosen to balance between accuracy and computational complexity. In some embodiments, the input layer (1202) contains M nodes, associated with the size of the RIS sensor array (input data). The hidden layers (1204) contain multiple nodes >L, where L is the number of RCM supported by the given RIS panel (e.g., 1110), and the output layer (1206) contains L nodes since each channel estimation corresponds to selection among a multi-class setup. If there are more layers in the neural network, the increase in the accuracy may be remarkable. Also, the network may become more complex due to increase in arithmetic operations. On the other hand, if there are fewer layers, the accuracy may decrease significantly. In some embodiments, to start with the training operation of the DNN, a weight matrix is initialized using some initialization strategies and is updated with each epoch according to the update equation as given below to reach the most accurate result.

$${W}_{new} = {W}_{old} - lr * {( {∇}_{W} L )}_{{W}_{old}}$$

Table 1 and Table 2 below show the various parameters used in the DNN model, in accordance with some embodiments of the present disclosure. Table 1 provides the training phase DNN parameters and Table 2 provides the hyper-parameters associated with the DNN.

TABLE 1

| Training parameter: | Parameter value/choice for DNN |
|---|---|
| Optimizer | An adaptive gradient descent optimizer |
| | (example: Adam) |
| Loss function (Cost Function) | Error matrix (example: Confusion |
| | matrix) |
| Metrics | Accuracy |

TABLE 2

| Hyper-parameter | Parameter value/choice for DNN |
|---|---|
| Number of input nodes | M = Number of RIS sensing elements |
| Number of output nodes | L = Number of reflections matrices |
| Number of hidden layers | 2 or more |
| Number of nodes in 1st hidden | (>L) |
| layer | |
| Number of nodes in 2nd hidden | (>L) |
| layer | |
| Activation function in the hidden | Piecewise Linear Function (example: |
| layers | ReLU, SELU, Swish, Leaky ReLU, |
| | Parametric ReLU, etc.) |
| Activation function in the output | A classifier activation function |
| layer | returns the probability of each class. |
| | It is used as an activation function |
| | for the last layer of the deep neural |
| | network in the case of multi-class |
| | classification. |

The following assumptions may be used in training the DNN.
1. The RIS controller (1130) may support a set of M beam RCM depending upon the physical characteristics and form factor of given RIS panel (1110), wherein this set of RCM forms a pre-programmed beamforming codebook for a given RIS system.
2. A preliminary phase of RIS training is already performed with the help of test UE to build up a beamforming codebook by the RIS controller (1130).

The use of DNN may therefore aid the RIS controller (1130) to make the optimal beamforming codeword choice in a standalone mode without any aid from the access point (1120). This minimizes the latency, complexity, and efficiency of the overall reflective beam forming process. The use of DNN for RCM selection provides one or more advantages including avoiding calculating the optimal RCM at every UE interaction, reducing the sync up with the access point (1120) on every UE reflection, saving the RIS controller from explicitly identifying the UE resource blocks (RBs), reduced latency, RIS functions anonymously improving channel quality of coverage region on the fly, and designing the DNN such that the selection/calculation of reflection coefficients for the untested DoA values is also done optimally.

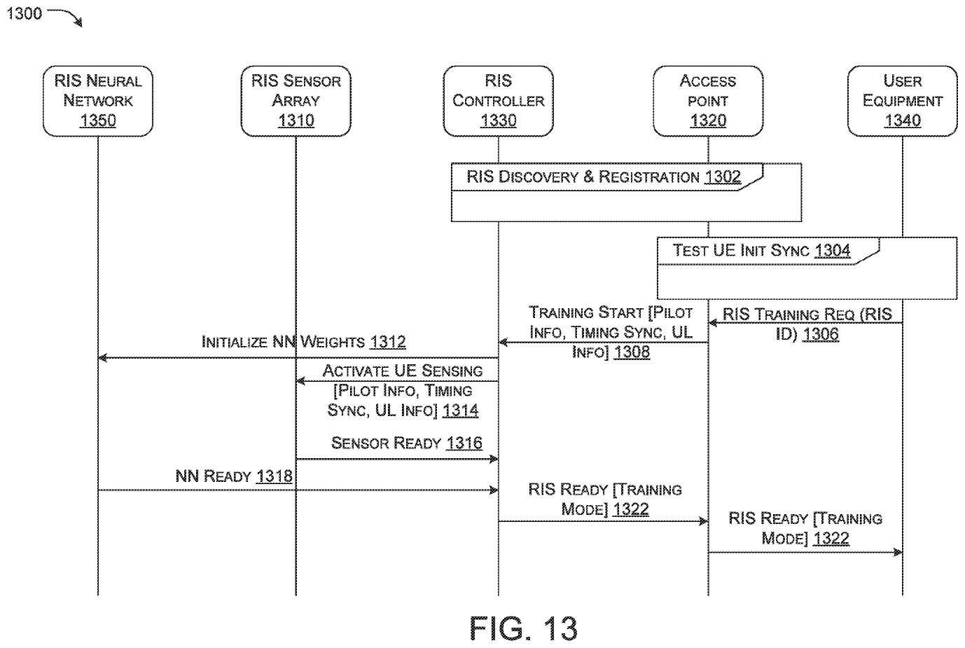

FIG. 13 illustrates an exemplary flow diagram (1300) associated with initializing the RIS training phase, in accordance with some embodiments of the present disclosure. In FIG. 13, one or more steps involved in initializing the training phase or process for autonomous beam forming at the RIS controller (1330) is shown.

The RIS controller (1330) may, at step 1302, perform a discovery and registration with the access point (1320). Further, the test UE (1340) may, at step 1304, initiate a sync with the access point (1320). Further, upon syncing of the test UE (1340) with the access point (1320), the test UE (1340) may, at step 1306, send a RIS training request to the access point (1320). The RIS training request includes a RIS identifier (ID). Further, the AP (1320) may, at step 1308, send a training start message to the RIS controller (1330). The training start message may include, but not limited to, a pilot information, timing sync, and an uplink information. Upon receiving the training start message, the RIS controller (1330) may, at step 1312, initialize the weights associated with the neural network (NN) (1350). The RIS controller (1330) may, at step 1314, activate the RIS sensing elements in the RIS array (1310). The activation message may include the pilot information, timing sync, and an uplink information. Upon receiving the activation message, the RIS array (1310) may, at step 1316, send a sensor ready signal to the RIS controller (1330). Further, the NN (1350) may, at step 1318, send a NN ready message to the RIS controller (1330). The RIS controller (1330), upon receiving the sensor ready signal and NN ready message, may at step 1322, send a RIS ready message to the access point (1320), wherein the access point (1320) forwards the message to the test UE (1340) signifying the start of the training. The Table 3 below specifies the one or more parameters used in the initialization of the training phase.

TABLE 3

| Training parameter | Description |
|---|---|
| RIS ID | Unique identification code of the given |
| | RIS controller for authorization and |
| | registration with the Basestation |
| NN WEIGHTS INIT | Initialization values of the Deep neural |
| | network weights |
| Pilot info (Sequence, seed, | The details of the class of Reference |
| Length) | symbol sequence allocated by given |
| | basestation to UE for uplink sounding |
| Timing sync | The information about frame and |
| | subframe timing sync to enable UL |
| | sensing at correct timing instance by |
| | RIS sensors |
| UL info | This is a TDD specific information. It |
| | provides the details of the UL and DL |
| | subframe distribution in a given Frame |
| | to the RIS controller. |

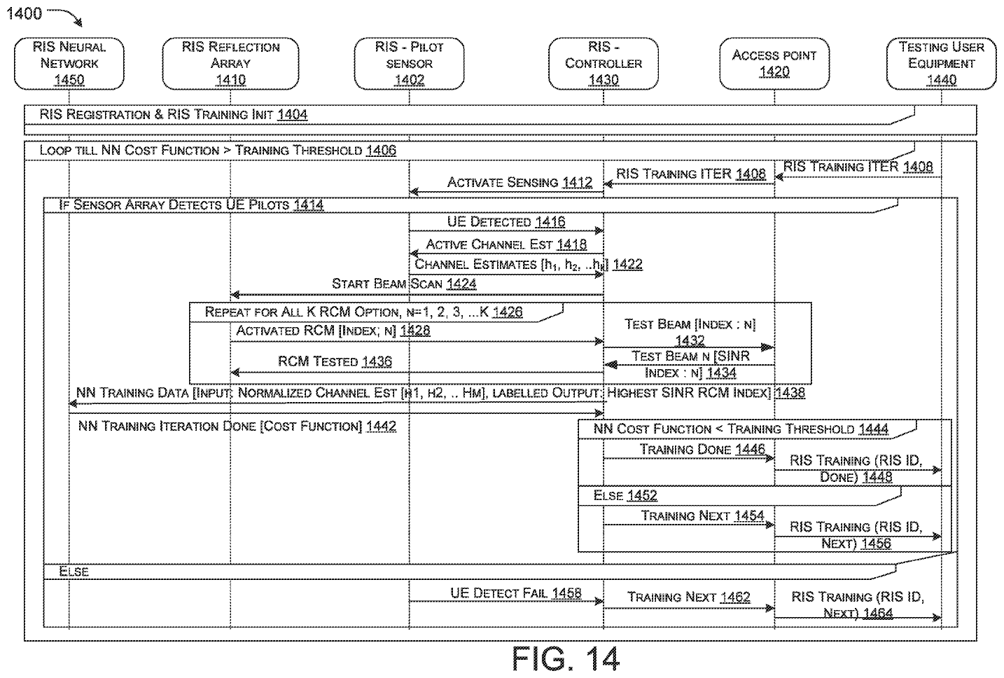

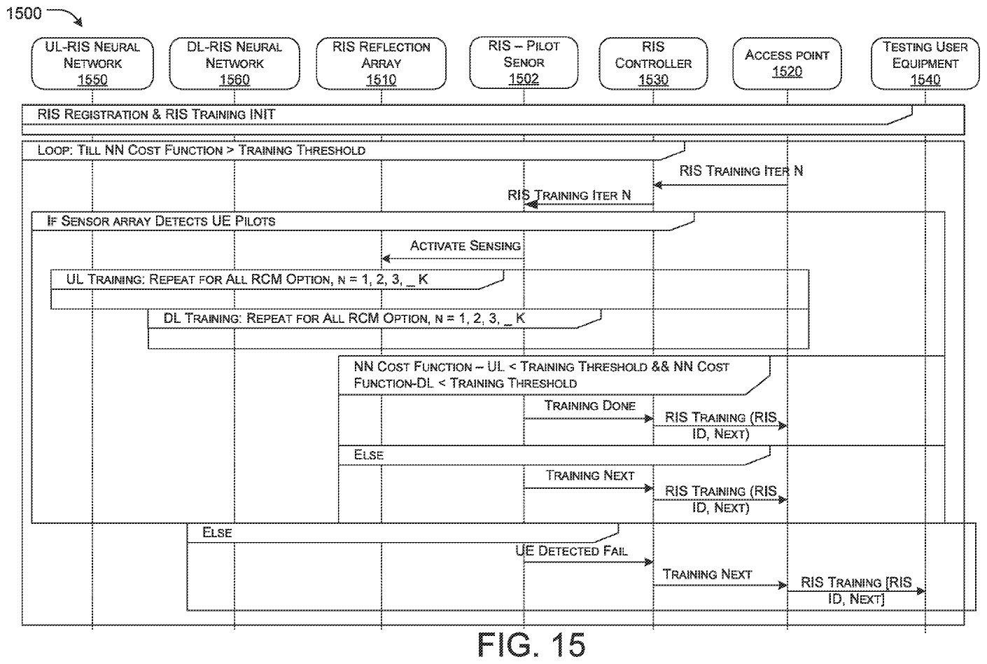

After initialization, the training may be performed based on the type of communication used, for example TDD or FDD, as discussed in detail below with reference to FIGS. 14 and 15.

FIG. 14 illustrates an exemplary flow diagram (1400) associated with RIS training for autonomous beam forming in TDD systems, in accordance with some embodiments of the present disclosure.

In FIG. 14, the steps for training a RIS NN (1450) in a TDD system is shown. The RIS controller (1430) may, at step 1404, register with the access point (1420). Upon registration of the RIS controller (1430), the training process may, at step 1406, start an iteration loop for obtaining RCM codebook based on different position of the test UE (1440). The test UE (1440) may, at step 1408, transmit reference signals from a first position (position #1) within an RIS coverage area to the access point (1420) which may be further transmitted to the RIS controller (1430). The RIS controller (1430) may, at step 1412, activate the sensing elements (1402) in the RIS panel (1410) to detect the test UE (1440). The sensing elements (1420) may, at step 1414, determine whether the UE pilots are detected. If the UE pilots are not detected, the sensing elements (1402) may, at step 1458, send a UE detect fail message to the RIS controller (1430). The RIS controller (1430) may, at step 1462, send a training next message to the access point (1420). The access point (1420) may further, at step 1462, forward a RIS training message with the RIS ID to the test UE (1440).

On the other hand, the sensing elements (1402) may further, at step 1416, inform the RIS controller (1430) if the test UE (1440) is detected. The RIS controller (1430) may, at step 1418, activate channel estimation upon detecting the test UE (1440). The RIS sensing elements (1402) may, at step 1422, perform channel estimation for the strongest path of the detected UE signal at each sensor on the RIS sensor array (1410) and send the estimation to the RIS controller (1430). The channel estimation is given by HK=[h1, h2, . . . , hM]−[1]. Upon receiving the channel estimation, the RIS controller (1430) may, at step 1424, start a beam scan by the RIS reflection array (1410). In some embodiments, the RIS controller (1430) varies its reflection coefficients according to a pre-designed reflection pattern in a stepwise manner, updates the access point (1420) at every step. The access point (1420) calculates an SINR for the test UE (1440) on each update and keeps calculating and recording the SINR of the test UE (1440) throughout the cycle or reflection pattern variation. At the end of one cycle of all possible reflection pattern variations (based upon a particular RIS array's capability), the access point (1420) reports back the reflection pattern corresponding to maximum SINR received in the first step of testing cycle to the RIS controller (1430). For example, the RIS controller (1430) may, at step 1426, include iterations to vary the RCM in a stepwise manner. This includes the RIS controller (1430) receiving, at step 1428, an activated RCM (index-n) from the RIS reflection array (1410), sending, at step 1432, a test beam (index-n) to the access point (1420), receiving, at step 1434, a test beam (index-n) from the access point (1420) with a SINR value, and sending, at step 1436, a RCM tested message to the RIS sensor array (1410).

Referring to FIG. 14, upon completing the iterations for RCM, the RIS controller (1430) may, at step 1438, train the RIS NN (1450) by feeding the M normalized channel estimates as an input and providing the selected set of reflection coefficients as the labelled outcome for an iteration. In some embodiments, the access point (1420) may update the test UE (1440) that the training iteration is now finished and the test UE (1440) may move to a different position within RIS coverage region. Further, the test UE (1440) may repeat the above steps to determine the next RCM for the new location.

Once the training is done, the RIS NN (1450) may, at step 1442, send a training done information with an associated cost function. The RISNN-logic keeps calculating the cost function as the training progresses. At step 1444, if the NN cost function has reached a pre-defined threshold, and when cost function approaches the pre-defined threshold, the RIS controller (1430) may update the access point (1420) with a training-complete message (1446). The access point (1420), at step 1448, informs the test UE (1440) the training complete status with a RIS ID. On the other hand, if the NN cost function does not approach the pre-defined threshold, the RIS controller (1430) may send a training next message, at step 1454, to the access point (1420) which in turn forwards the message, at step 1456, to the test UE (1440) with the RIS ID.

The various parameters involved in training the RIS NN (1450) are shown in Table 4 below.

TABLE 4

| Training parameter | Description |
|---|---|
| COST FUNCTION | A cost measure of the accuracy of Deep |
| | neural network output compared to the |
| | labelled target outputs during training |
| | phase |
| TRAINING THRESHOLD | A target threshold value of COST |
| | FUNTION below which the training is |
| | assumed to be acceptable for testing & |
| | deployment. |
| H_{K} = [h₁, h₂, . . . , h_{M}] | The M strongest channel paths from |
| | UE uplink detected at the M sensors of |
| | the RIS RF array. |

FIG. 15 illustrates an exemplary flow diagram (1500) associated with RIS training for autonomous beam forming in FDD systems, in accordance with some embodiments of the present disclosure.

In FIG. 15, the steps for training a UL RIS NN (1550) and a DL RIS NN (1560) in a FDD system is shown. Training the UL RIS NN (1550) and the DL RIS NN (1560) involve a similar set of steps as mentioned above for training the RIS NN (1450) with reference to FIG. 14. The difference between the TDD system and the FDD system is that the FDD system operates the UL and DL in separate frequency, and therefore, the channel reciprocity becomes invalid. Hence, different reflection coefficient matrices are required for reflecting UL and DL links for the same UE. Therefore, to enable training for FDD systems, the RIS reflection array (1510) is virtually divided into two sections each having N/2 reflection and M/2 sensing elements, such that one section caters for uplink and the other section caters for downlink. All the training steps discussed above for the TDD system with reference to FIG. 14 apply to the training of the FDD system. As would be appreciated by a person skilled in the art, the discussion is not repeated here for the sake of brevity. Further, in the FDD system, a second training phase may be implemented with the access point (1520) transmitting in the DL and the test UE (1540) performing channel estimation for various DL reflection codewords at a given UE location.

Referring to FIG. 15, the UL RIS NN (1550) may include the RCM codebook related to reflective beam forming at the RIS surface (1510) for uplink communication (from UE (1540) to the access point (1520)) and the DL RIS NN (1560) may include RCM codebook related to reflective beam forming at the RIS surface (1510) for downlink communication (from the access point (1520) to the UE (1540)).

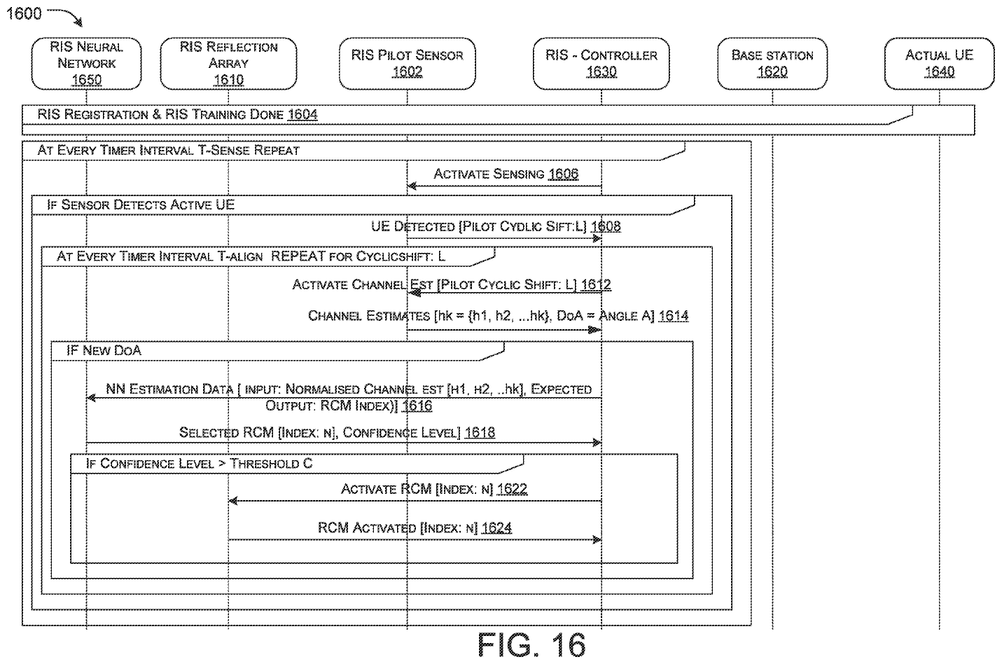

FIG. 16 illustrates an exemplary flow diagram (1600) associated with autonomous beam forming at the RIS in a practical implementation, in accordance with some embodiments of the present disclosure.

In FIG. 16, the signal flow associated with a practical deployment scenario of the autonomous beam forming system is shown. The practical deployment scenario includes one or more of the following considerations:
1. The reflection coefficients chosen by RIS controller are directly mapped to the relative UE location.
2. In the example embodiment, the DoA is the indicator of relative UE location.
3. The change in UE location may be detected by the RIS sensor (1602) array as a change in DoA from the UE.

In some embodiments, to enable reliable estimation of Direction of arrival (DoA=[AoA Horizontal, AoA Vertical]) of the UL signal at the RIS array, the size of the steering matrix (M) used for estimation of Direction of arrival should be long enough to provide good correlation properties. The steering matrix is give as:

$$A = [ \begin{matrix}a ( {θ}_{1} ) & a ( {θ}_{2} ) & … & a ( {θ}_{M} )\end{matrix} ]$$

$$a ( {θ}_{B} ) = {[ \begin{matrix}1 & {e}^{j μ} & … & {e}^{j ( M - 1 ) μ}\end{matrix} ]}^{T} ,$$

$$where$$

$$μ = - k Δ sin {B}_{}$$

In some embodiments, once the RIS controller (1630) is trained and registered with the AP (1620) and is provisioned to on field deployment, the RIS controller (1630) keeps activating RIS sensor array (1602) periodically to sense for an active UE (1640) in its vicinity. Once the RIS sensor array (1602) detect an active UE (1640) in its vicinity, the RIS controller (1630) is updated to initiate RCM selection process. The RIS controller (1630) activates the complete sensor array (1602) to calculate an accurate normalized UL channel estimate in spatial domain. The M normalized channel estimates are fed as an input to the pre-trained DNN (1650). The DNN (1650) generates an output of selection of appropriate RCM for the given UE (1640).

Referring to FIG. 16, the practical deployment may include, at step 1604, completing the registration of the RIS controller (1630) with the access point (1620) and completing the training of the RIS NN (1650). The RIS controller (1630) may, at step 1606, activate the RIS sensor array (1602) to sense an active UE (1640) in the RIS coverage area. The RIS sensor array (1602) may, at step 1608, send a UE detected message along with a pilot carrier to the RIS controller (1630). The RIS controller (1630) may further, at step 1612, activate the channel estimation based on the cyclic shift in the pilot carrier. The RIS sensor array (1610) may further, at step 1614, send channel estimates with a direction of arrival (DoA) angle A to the RIS controller (1630). The RIS controller (1630) may further, at step 1616, send a normalized channel estimate as input to the RIS NN (1650). The RIS NN (1650) may, at step 1618, send a selected RCM along with a confidence level. The RIS controller (1630) may check whether the confidence level is greater than a threshold. The RIS controller (1630) may, at step 1622, activate the RCM index for the RIS reflection array (1610) if the confidence level is greater than the threshold. The reflection array (1610) may, at step 1624, send a RCM activated confirmation message to the RIS controller (1630). The RIS reflective array (1610) may use the selected RCM for relaying the beam from the active UE (1640) to the access point (1620).

Table 5 shows the various algorithm parameters used for dynamic UE tracking and beam selection.

TABLE 5

| Tracking parameters | Description |
|---|---|
| T-sense | A Timer preset value after which the |
| | sensors wills be activated periodically |
| | to sense the presence of an active UE in |
| | its coverage. |
| | This Timer preset is valid only if the |
| | RIS sensor is not already tracking an |
| | active UE. |
| T-align | This is a timer preset value used when |
| | RIS sensors are tracking an active UE |
| | in its coverage. |
| | The normalized channel estimates and |
| | respective Direction of arrival of UE |
| | UL signals is refreshed every T-align |
| | seconds. |
| Pilot Cyclic Shift | Pilot Cyclic shift is the cyclic shift |
| | value at which the UL pilot sequence is |
| | sensed. |
| | It should be noted that each unique |
| | Cyclic Shift corresponds to a particular |
| | UE. Hence, in tracking mode the RIS |
| | sensors keep using the detected Cyclic |
| | Shift for tracked UE. |
| CONFIDENCE LEVEL | This parameter reflects the confidence |
| | level (probability) of classification in |
| | current NN iteration. |
| Threshold-C | This is a threshold of CONFIDENCE |
| | LEVEL which should be the selection |
| | criterion of accepting or rejecting the |
| | selected RCM by the RIS Deep neural |
| | network in current iteration. |

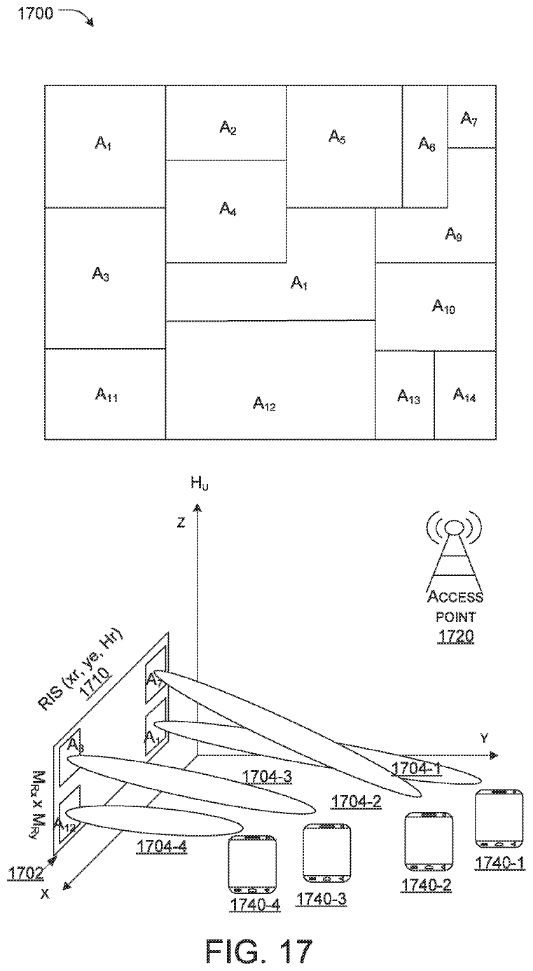

FIG. 17 illustrates an exemplary autonomous beaming forming system (1700) at the RIS for supporting multiple UEs, in accordance with some embodiments of the present disclosure.

In FIG. 17, a single RIS array 1710 supporting multiple reflective beam forming (1704-1 . . . 1704-4) for multiple UEs (1740-1 . . . 1740-4) is shown. In some embodiments, the RIS meta surface may be virtually divided into non-uniform sub-arrays (A1-A14). Further, a reflective beam forming may be initiated in the one or more non-uniform sub-arrays by the RIS controller to cater individual UEs. For example, UE 1 (1740-1) may be catered by the reflective beam forming (1704-1) from a first sub-array A₁. Similarly, other UEs may be catered by the reflective beam forming from other sub-arrays. In accordance with some embodiments, a time/frequency scheduling may be implemented among the non-uniform sub-arrays such that one sub-array forms the reflective beam at one particular time/frequency.

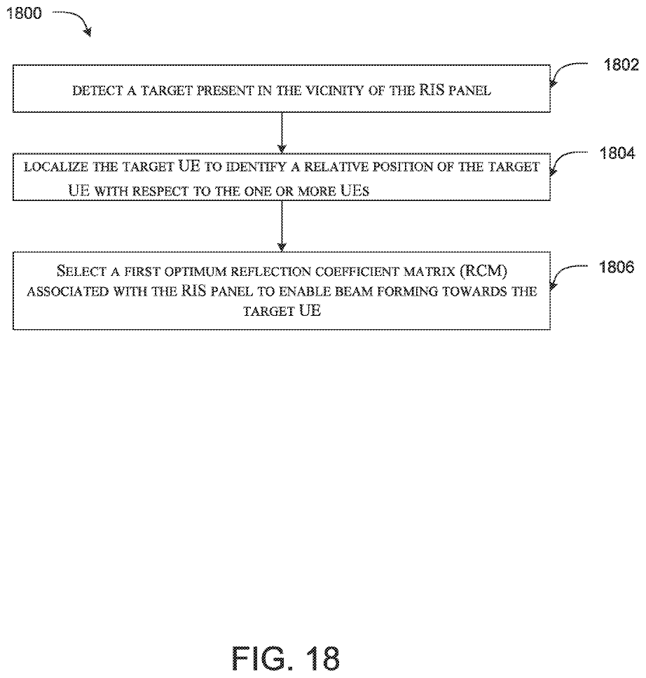

FIG. 18 illustrates an exemplary flow chart for a method (1800) for enabling autonomous beamforming in a wireless network, in accordance with some embodiments of the present disclosure. In FIG. 18, the method (1800) for enabling autonomous beamforming at the RIS controller is discussed. The method (1800) may include, at step 1802, detecting a target UE present in the vicinity of the RIS panel. The target UE may be within a line of sight of the RIS panel or may be within a signal reception distance. Further, the method (1800) may include, at step 1804, localizing the target UE to identify a relative position of the target UE with respect to the one or more UEs. The method (1800) may further include, at step 1806, selecting a first optimum RCM associated with the RIS panel to enable beam forming towards the target UE.

A person of ordinary skill in the art will appreciate that these are mere examples, and in no way, limit the scope of the present disclosure.

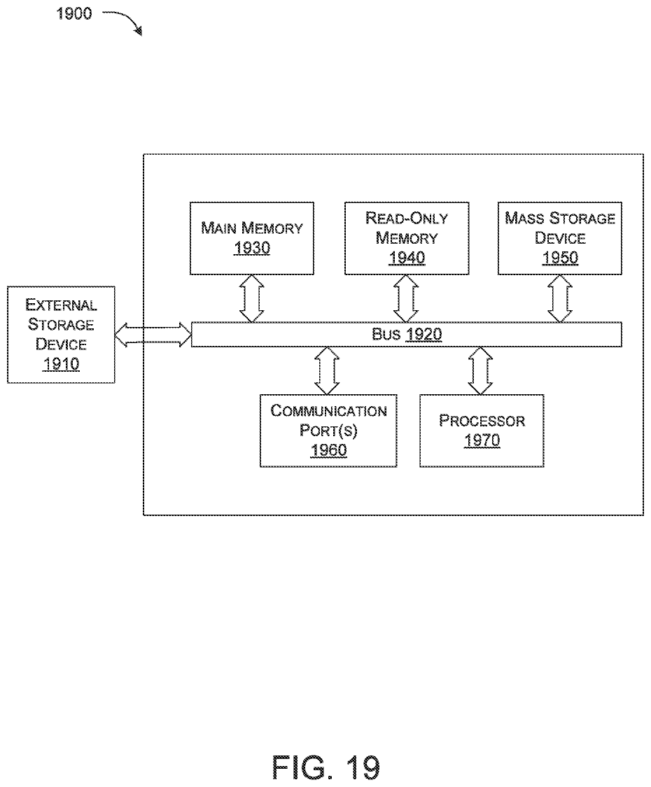

FIG. 19 illustrates an exemplary computer system (1900) in which or with which embodiments of the present disclosure may be utilized. As shown in FIG. 19, the computer system (1900) may include an external storage device (1910), a bus (1920), a main memory (1930), a read-only memory (1940), a mass storage device (1950), communication port(s) (1960), and a processor (1970). A person skilled in the art will appreciate that the computer system (1900) may include more than one processor and communication ports. The processor (1970) may include various modules associated with embodiments of the present disclosure. The communication port(s) (1960) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (1960) may be chosen depending on a network, such a Local Area Network (LAN), Wide Area Network (WAN), or any network to which the computer system (1900) connects. The main memory (1930) may be random access memory (RAM), or any other dynamic storage device commonly known in the art. The read-only memory (1940) may be any static storage device(s) including, but not limited to, a Programmable Read Only Memory (PROM) chips for storing static information e.g., start-up or basic input/output system (BIOS) instructions for the processor (1970). The mass storage device (1950) may be any current or future mass storage solution, which may be used to store information and/or instructions.

The bus (1920) communicatively couples the processor (1970) with the other memory, storage, and communication blocks. The bus (1920) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (1970) to the computer system (1900).

Optionally, operator and administrative interfaces, e.g. a display, keyboard, and a cursor control device, may also be coupled to the bus (1920) to support direct operator interaction with the computer system (1900). Other operator and administrative interfaces may be provided through network connections connected through the communication port(s) (1960). In no way should the aforementioned exemplary computer system (1900) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides an autonomous reflection beam forming at a reconfigurable intelligent surface (RIS) reducing latency associated with existing reflection beam forming techniques.

The present disclosure provides a deep neural network (DNN) based reflection code matrix (RCM) selection at the RIS.

The present disclosure provides reduced computation associated with calculating the optimal reflection coefficient matrix for every user equipment (UE) interaction.

The present disclosure provides dynamic channel quality improvement in a RIS coverage region.

The present disclosure provides an advanced communication system.

The present disclosure enhances the user experience.

The present disclosure solves one or more network related issues such as call drops and signal strength.

The present disclosure provides a joint sensing and communication system.

The present disclosure provides an advanced joint sensing and communication system using IRS for autonomous beam management and tracking.

We claim:

1. A system (1100) for enabling autonomous beam forming in a wireless network, said system (1100) comprising:
a reconfigurable intelligent surface (RIS) controller (1130) associated with a RIS panel (1110) enabling a communication between an access point (1120) and one or more user equipments (UEs) (1140) in the wireless network, wherein the RIS controller (1130) is configured to:
detect a target UE (1140-2) present in the vicinity of the RIS panel (1110) based on one or more signals received from the target UE;
localize the target UE (1140-2) to identify a relative position of the target UE (1140-2) with respect to the one or more UEs (1140); and
select a first optimum reflection coefficient matrix (RCM) associated with the RIS panel (1110) to enable beam forming towards the target UE (1140-2).

2. The system (1100) as claimed in claim 1, wherein the selected first optimum RCM enables optimal reflection of a beam from the access point (1120) towards the target UE (1140-2).

3. The system (1100) as claimed in claim 1, wherein the RIS panel (1110) comprises one or more reflecting elements (502) and one or more sensing elements (504).

4. The system (1100) as claimed in claim 3, wherein the one or more sensing elements (504) assist the RIS controller (1130) to:
detect the presence of the target UE (1140-2); and
detect a movement associated with the target UE (1140-2).

5. The system (1100) as claimed in claim 3, wherein the RIS controller (1130) is configured to:
receive, from the one or more sensing elements (504), one or more uplink (UL) transmissions associated with the target UE (1140-2); and
estimate an angle of arrival (AoA) associated with the target UE (1140-2) based on the received one or more UL transmissions.

6. The system (1100) as claimed in claim 4, wherein the RIS controller (1130) is configured to:
select a second optimum RCM based on the detected movement associated with the target UE (1140-2).

7. The system (1100) as claimed in claim 6, wherein the RIS controller (1130) is configured to select the first and the second optimum RCM from a RCM lookup table obtained based on training a neural network for different RCM associated with different UE locations.

8. The system (1100) as claimed in claim 6, wherein the RIS controller (1130) is configured to:
form reflection beams based on at least one of the selected first and second optimum RCM to direct one or more signals from the access point (1120) towards the target UE (1140-2).

9. The system (1100) as claimed in claim 3, wherein the RIS controller (1130) is configured to:
group the one or more reflecting elements (502) and the one or more sensing elements (504) in an array to form a plurality of non-uniform sub-arrays; and
create an operating schedule for the plurality of non-uniform sub-arrays to serve the one or more UEs (1140) in the wireless network.

10. A method (1800) for enabling autonomous beam forming in a wireless network comprising a reconfigurable intelligent surface (RIS) controller (1130) associated with a RIS panel (1110) enabling communication between an access point (1120) and one or more user equipments (UEs) (1140), said method comprising:
detecting (1802), by the RIS controller (1130), a target UE (1140-2) present in the vicinity of the RIS panel (1110) based on one or more signals received from the target UE (1140-2);
localizing (1804), by the RIS controller (1130), the target UE (1140-2) to identify a relative position of the target UE (1140-2) with respect to the one or more UEs (1140); and
selecting (1806), by the RIS controller (1130), a first optimum reflection coefficient matrix (RCM) associated with the RIS panel (1110) to enable beam forming towards the target UE (1140-2).

11. The method (1800) as claimed in claim 10, wherein the selected first optimum RCM enables optimal reflection of a beam from the access point (1120) towards the target UE (1140-2).

12. The method (1800) as claimed in claim 10, wherein the RIS panel (1110) comprises an array of one or more reflecting elements (502) and one or more sensing elements (504).

13. The method (1800) as claimed in claim 12, comprising:
detecting, by the RIS controller (1130) via the one or more sensing elements (504), at least one of: the presence of the target UE (1140-2), and a movement associated with the target UE (1140-2).

14. The method (1800) as claimed in claim 12, comprising:
receiving, by the RIS controller (1130), one or more uplink (UL) transmissions associated with the target UE (1140-2) from the one or more sensing elements (504); and
estimating, by the RIS controller (1130), an angle of arrival (AoA) associated with the target UE (1140-2) based on the received one or more UL transmissions.

15. The method (1800) as claimed in claim 13, comprising:
selecting, by the RIS controller (1130), a second optimum RCM based on the detected movement associated with the target UE (1140-2).

16. The method (1800) as claimed in claim 12, comprising:
grouping, by the RIS controller (1130), the one or more reflecting elements (502) and the one or more sensing elements (504) in the array to form a plurality of non-uniform sub-arrays; and
creating, by the RIS controller (1130), an operating schedule for the plurality of non-uniform sub-arrays to serve the one or more UEs (1140) in the wireless network.

17. The method (1800) as claimed in claim 15, comprising:
selecting, by the RIS controller (1130), the first and the second RCM from a RCM lookup table obtained based on training a neural network for different RCM associated with different UE locations.

18. The method (1800) as claimed in claim 15, comprising:
forming, by the RIS controller (1130), reflection beams based on at least one of the selected first and second optimum RCM to direct one or more signals from the access point (1120) towards the target UE (1140-2).

19. A user equipment (UE), comprising:
one or more processors; and
a memory operatively coupled to the one or more processors, wherein the memory comprises processor-executable instructions, which on execution, cause the one or more processors to:
transmit one or more uplink (UL) signals to a reconfigurable intelligent surface (RIS) controller (1130) to provide a location of the UE; and
receive signals from an access point (1120) through one or more reflection beams formed by the RIS controller (1130) based on a selected optimal reflection coefficient matrix (RCM).

20. A non-transitory computer readable medium comprising one or more instructions stored thereupon that when executed by a processor cause the processor to:
detect a target user equipment (UE) (1140-2) present in the vicinity of a reconfigurable intelligent surface (RIS) panel (1110) based on one or more signals received from the target UE (1140-2);
localize the target UE (1140-2) to identify a relative position of the target UE (1140-2) with respect to one or more UEs (1140) present in a wireless communication network; and
select an optimum reflection coefficient matrix (RCM) associated with the RIS panel (1110) to enable beam forming towards the target UE (1140-2).
